(19) United States
(12) Patent Application Publication
(10) Pub. No.: US 2019/0122157 A1
(43) Pub. Date: Apr. 25, 2019

(54) SYSTEMS AND METHODS FOR DEPLOYING GROUPS OF SELF-DRIVING MATERIAL-TRANSPORT VEHICLES

(71) Applicant: Clearpath Robotics Inc., Kitchener (CA)

(72) Inventors: Sam Adrian Jenkins, Waterloo (CA); Smriti Chopra, Waterloo (CA); Andrei Petru Ionescu, Waterloo (CA); Ryan Christopher Gariepy, Kitchener (CA)

(21) Appl. No.: 16/167,837

(22) Filed: Oct. 23, 2018

Related U.S. Application Data
(60) Provisional application No. 62/575,656, filed on Oct. 23, 2017.

(51) Int. Cl. G06Q 10/06; G05D 1/02

(52) U.S. Cl. CPC G06Q 10/06315; B60L 11/1809; G05D 1/0291

(57) ABSTRACT

Systems and methods for deploying groups of self-driving material-transport vehicles are presented. The system comprises a fleet of self-driving material-transport vehicles having two or more vehicle teams and a fleet-management system. The fleet-management system has a processor and non-transitory computer-readable media comprising instructions that, when executed by the processor, configure the processor to receive a request for an event to be executed, select a vehicle team from within the fleet based on the request, select a vehicle from within the vehicle team, and transmit event directions to the selected vehicle based on the request for the event. The selected vehicle then executes the event directions.

### CROSS-REFERENCE TO RELATED APPLICATIONS

This application claims priority to U.S. Provisional Patent Application No. 62/575,656, filed 23 Oct. 2017, and titled “SYSTEMS AND METHODS FOR DEPLOYING GROUPS OF SELF-DRIVING MATERIAL-TRANSPORT VEHICLES”, the contents of which are incorporated herein by reference for all purposes.

### TECHNICAL FIELD

The described embodiments relate to systems and methods for materials handling in an industrial facility, and in particular to deploying groups of self-driving material-transport vehicles.

### BACKGROUND

Self-driving material-transport vehicles are used to move payloads such as parts and inventory throughout industrial facilities such as factories and warehouses according to the requirements of business logic and process management pertaining to the facilities. Generally, multiple vehicles, collectively forming a fleet of vehicles, may be used within a single facility. The vehicles may communicate with and receive instructions from a fleet-management system.

As the size of industrial facilities and, therefore, vehicle fleets increase, the types of particular tasks performed by the vehicles increases. Typically, a single fleet-management system is confined to a particular type of vehicle, a particular location within a large facility or campus, and/or a maximum fleet size. However, in some cases, it may be desirable to operate a single instance of a fleet-management system.

As such, there is a need for a fleet-management system, a single instance of which, can manage a fleet of vehicles independent of vehicle types, vehicle characteristics, vehicle and mission locations within the facility, and fleet size.

### SUMMARY

In a first aspect, there are non-transitory computer-readable media comprising one or more instructions for assigning an event to a fleet of self-driving vehicles. When executed on a processor, the instructions configure the processor to receive a request for the event to be executed, select a vehicle team from within the fleet based on the request, select a vehicle from within the vehicle team, and transmit event directions to the selected vehicle based on the request for the event.

According to some embodiments, the instructions may further configure the processor to, prior to selecting the vehicle team from within the fleet, selecting an agent from among a plurality of agents based on the request. Selecting the vehicle from within the fleet based on the request is based on the selected agent.

According to some embodiments, the event is a self-driving vehicle mission and the agent is a mission-scheduling agent.

According to some embodiments, the mission pertains to a mission region. The fleet may comprise two or more vehicle teams defined based on respective team regions, and the vehicle team may be selected based on the mission region and the two or more team regions.

According to some embodiments, the request is a battery-charge request based on vehicle state information of a low-charge vehicle, and the agent is a charging agent.

According to some embodiments, the fleet comprises two or more vehicle teams defined based on respective team regions, and the event directions comprise a charging-station location selected based on the respective team region associated with the vehicle team comprising the low-charge vehicle.

According to some embodiments, the fleet comprises two or more vehicle teams defined based on respective charging station types, and the event directions comprise a charging-station location selected based on the respective charging station type associated with the vehicle team comprising the low-charge vehicle.

According to some embodiments, the event is a maintenance event based on vehicle-state information from a disabled vehicle, the agent is a maintenance agent, and the maintenance agent adds a replacement vehicle to the vehicle team associated with the disabled vehicle.

In a second aspect, there is a system for materials handling using a fleet of self-driving vehicles. The system comprises two or more vehicle teams that comprise the fleet of self-driving vehicles and a fleet-management system. The fleet-management system has a processor and non-transitory computer-readable media comprising instructions that, when executed on the processor, configure the processor to provide a fleet-manager interface for receiving a mission request, provide at least one agent for selecting a vehicle from within the selected vehicle team based on the mission request, and transmit mission directions to the selected vehicle based on the mission request. The fleet-manager interface is a single fleet-manager interface configured to receive mission requests pertaining to any of the vehicle teams.

According to some embodiments, two or more vehicle teams may be defined based on vehicle payload capacity such that all vehicles in each team have the same payload capacity as each other, and all vehicles in each team have a different payload capacity as vehicles in other vehicle teams.

According to some embodiments, two or more vehicles teams may be defined based on team regions such that all vehicles in each team have the same team region as each other, and all vehicles in each team have a different team region as vehicles in other vehicle teams.

In a third aspect, there is a method for assigning an event to a fleet of self-driving vehicles. The method comprises receiving, with a fleet-management computer system, a request for the event to be executed, selecting a vehicle team from within the fleet based on the request, selecting a vehicle from within the vehicle team, transmitting event directions to the selected vehicle based on the request for the vent, and executing the event directions with the selected vehicle.

### BRIEF DESCRIPTION OF THE DRAWINGS

A preferred embodiment of the present invention will now be described in detail with reference to the drawings, in which:

FIG. 1 is a system network diagram depicting a system for materials handling in an industrial facility utilizing vehicle teams based on vehicle characteristics according to some embodiments;

FIG. 2 is a system network diagram depicting a system for materials handling in an industrial facility utilizing vehicle teams based on mission regions according to some embodiments;

FIG. 3 is isometric views of four exemplary vehicles based on vehicle types and characteristics according to some embodiments;

FIG. 4 is a data table representing vehicle team definitions according to some embodiments;

FIG. 5 is a system diagram of a fleet-management system according to some embodiments; and

FIG. 6 is a flow diagram of a method of assigning an event to a fleet of self-driving vehicles according to some embodiments.

### DETAILED DESCRIPTION

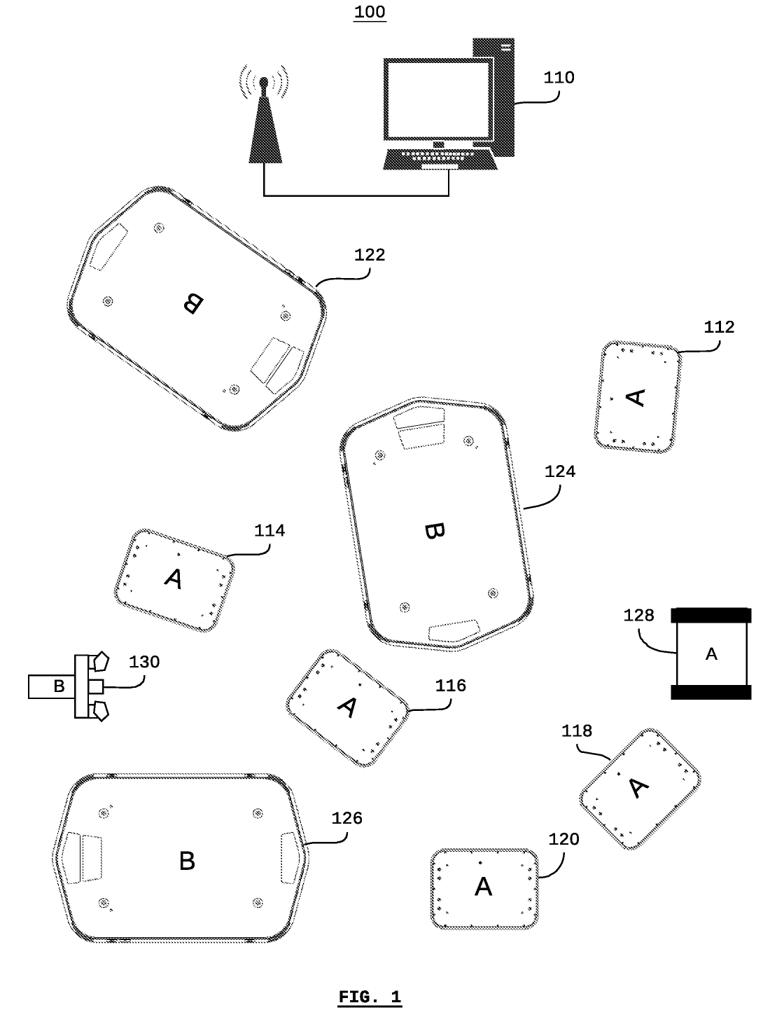

Referring to FIG. 1, there is shown a system 100 for materials handling in an industrial facility such as a factory or warehouse. The system 100 comprises a fleet-management system 110 in wireless communication with self-driving material transport vehicles individually labelled 112 to 126, which can be collectively referred to as a fleet of self-driving material transport vehicles.

According to some embodiments, the fleet-management system 110 comprises a computer system and wireless communications equipment, with the computer system having a processor, program memory, and non-transitory computer-readable media that store instructions that, when executed on the processor, configure the processor to perform fleet-management operations as further described below.

The fleet shown in the example of FIG. 1 can be considered as comprising two vehicle teams. Team “A” comprises the vehicles 112 to 118, which are labelled “A”. Team “B” comprises the vehicles 120 to 126, which are labelled “B”.

According to some embodiments, vehicle teams may be defined based on vehicle types. As shown, Team A comprises a single vehicle type and Team B comprises a single vehicle type that is different from the vehicle type of Team A. In other words, all of the vehicles in one team may be of the same type as each other, and all of the vehicle in each team may be of a different type than the vehicles in the other teams. A vehicle type may be indicative of any vehicle characteristics, such as a vehicle's speed, length, width, height, carrying capacity (e.g. max payload), appliances, interfaces, and other equipment installed on the vehicle.

The system 100 may also include charging stations for charging the vehicles, such as in the case of electric vehicles. A first charging station 128 is shown, which is compatible with the type of vehicles in Team A. A second charging station 130 is shown, which is compatible with the type of vehicles in Team B. According to some embodiments, a particular type of vehicle may only be compatible with particular types of charging stations. As such, the type of compatible charging station may also be considered as a vehicle characteristics, which may be used as the basis for defining a vehicle team.

According to some embodiments, a single fleet-management system 110 (e.g. a single instance of a fleet-management application running on a computer system) can operate in order to manage the fleet by managing Team A and Team B independently.

For example, Team A and Team B may be defined based on the maximum payload of the vehicles. If a particular type of mission is requested that involves a payload that only the vehicles in Team B can accommodate, then the fleet-management system 110 may manage Team B in order to fulfill the mission request, without having to consider the vehicles in Team A while doing so.

Similarly, Team A and Team B may be defined based on the type of vehicle charging station that each vehicle can use. If a vehicle-charge event is requested in association with a vehicle in Team A, then the fleet-management system 110 can manage the request based on the charging station 128 that is compatible with the vehicles of Team A, independently of the non-compatible charging station 130.

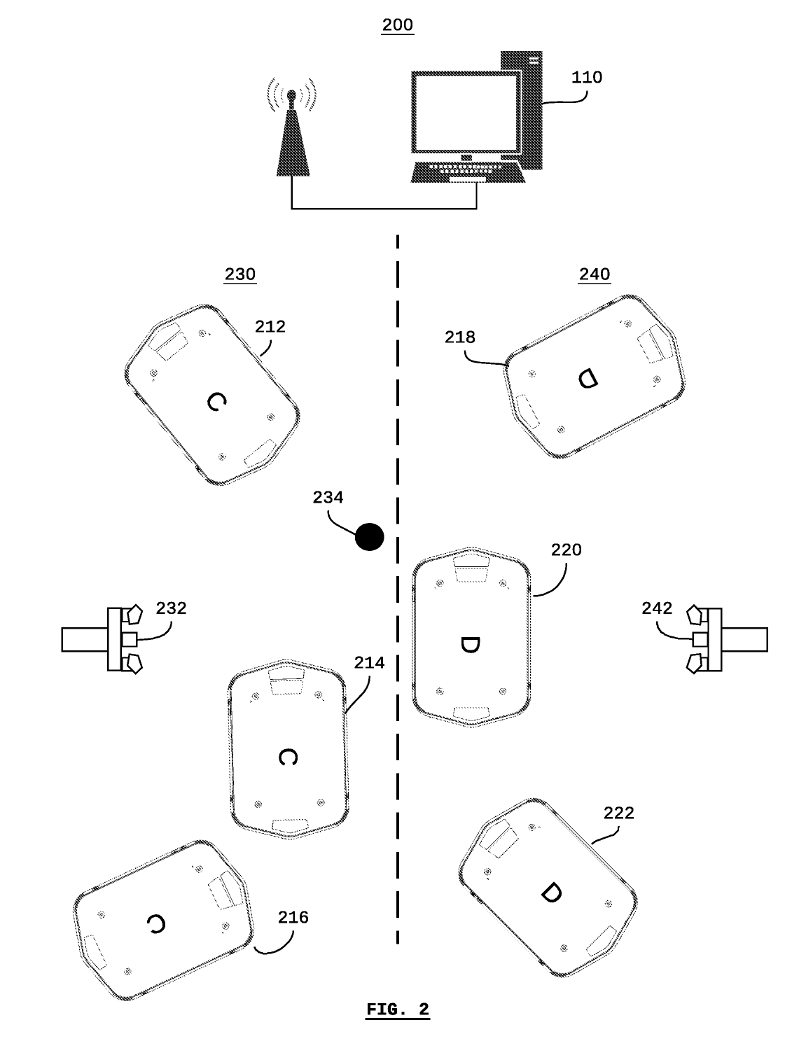

Referring to FIG. 2, there is shown a system 200 for materials handling. The system 200 comprises a fleet-management system 110, as generally described in respect of FIG. 1, in wireless communication with self-driving material transport vehicles individually labelled 212 to 222.

The system 200 may operate in an industrial facility such as a factory or warehouse. According to some embodiments, the facility may be organized into two or more mission regions. A first mission region 230 and a second mission region 240 are shown, as separated by the dashed line.

The fleet shown in the example of FIG. 2 can be considered as comprising two vehicle teams. Team “C” comprises the vehicles 212 to 216, which are labelled “C”. Team “D” comprises the vehicles 218 to 222, which are labelled “D”.

According to some embodiments, vehicle teams may be defined based on team regions (i.e. location-based). As shown, Team C operates within the mission region 230, and Team D operates within the mission region 240. In this case, the team region for Team C corresponds to the mission region 230, and the team region for Team D corresponds to the mission region 240. The mission region 230 includes the charging station 232, and the mission region 240 includes the charging station 242.

Mission regions may be defined in various ways. For example, the first mission region 230 may be associated with one assembly line in a factory, and the second mission region 240 may be associated with another assembly line in the same factory. In this way, Team C can work in association with the first assembly line while Team D works in association with the second assembly line, and independently from Team C.

Similarly, in the case of a warehouse, the mission region 230 may be associated with an inventory storage area, and the mission region 240 may be associated with a shipping area.

Similarly, in the case of an industrial campus that includes more than one building, the mission region 230 may be located in one building and the mission region 240 may be located in another building. The campus may share communications networking infrastructure such that the fleet-management system 110 can be located anywhere, while maintaining communications with the vehicles.

In use, missions that are associated with the mission region 230 (e.g. the first assembly line) can be executed by selecting a vehicle from Team C, while missions that are associated with the mission region 240 (e.g. the second assembly line) can be executed by selecting a vehicle from Team D.

For example, a mission request may be received that includes sending a vehicle to a mission location 234 within the mission region 230. Without the definition of vehicle teams based on team regions, the fleet-management system 110 may have otherwise selected the vehicle 220 to execute the mission. However, with the use of vehicle teams based on team regions, Team C is managed independently of Team D.

According to some embodiments, this may tend towards improved system certainty and stability, since the distribution of the fleet within the area of the industrial facility can be maintained in accordance with the distribution of mission locations. In some cases, for example, when each mission region corresponds to a particular assembly line, assembly stage, process, warehouse area, etc., if a problem is experienced in one mission region or vehicle team, then the problem is contained to that mission region or team while the other teams, operating in the other mission regions, continue to operate unaffected. Likewise, the possibility of a corner case emerging where a vehicle close to the boundaries but not within a particular area is brought into the area, not allowed to leave, and thus negatively impacting another area is removed entirely.

Similarly, a vehicle-charge event request may be received in association with the vehicle 214. In this example, each mission region includes its own charging station, and all vehicles in the fleet are compatible with all charging stations. Without the definition of vehicle teams based on team regions, the fleet-management system 110 may have otherwise selected the charging station 242, since, for example, the charging station 232 may have been temporarily unavailable (e.g. another vehicle was charging). However, with the use of vehicle teams based on team regions, the fleet-management system 110 may send the vehicle 214 to wait until the charging station 232 is available rather than sending it to the charging station 242, which is reserved for Team D.

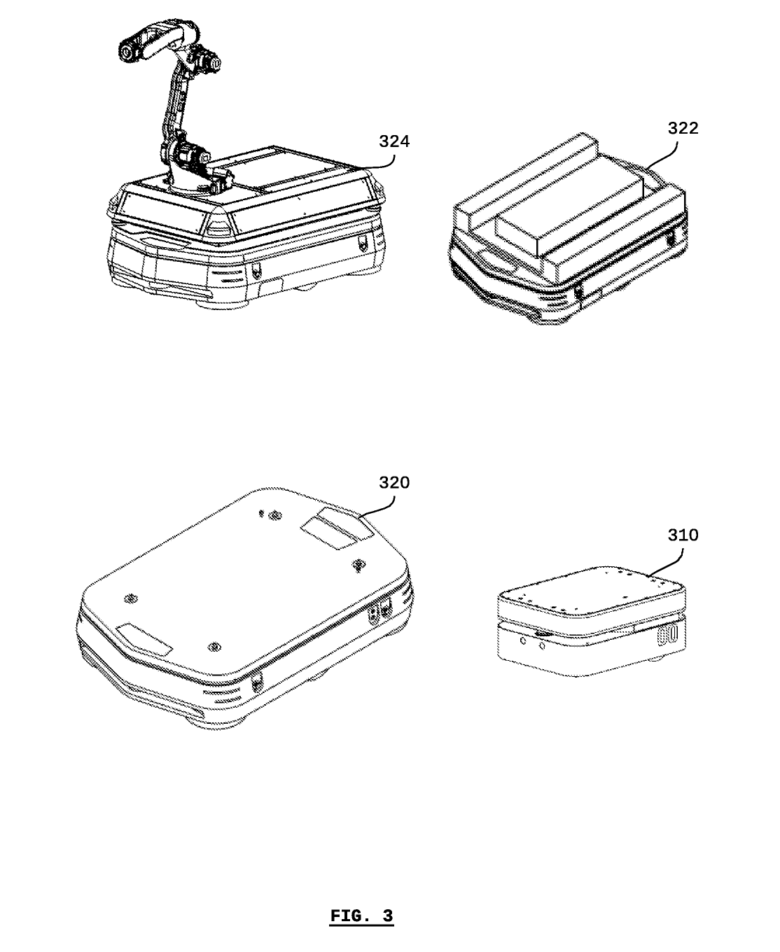

Referring to FIG. 3, there are shown four examples of industrial self-driving vehicles with different vehicle characteristics, according to some embodiments. The vehicles shown in FIG. 3 represent four of many different vehicle characteristics, and are exemplary but not exhaustive of vehicle types and characteristics.

The industrial self-driving vehicle 310 and the industrial self-driving vehicle 320 may be said to be of different vehicle types. According to some embodiments, vehicles of different types may have different dimensions (e.g. length, width, height), different driving characteristics (e.g. speed, maneuverability, space required to safely operate around other objects), different payload capacities, etc. For example, the vehicle 310 may be the type of vehicle upon which Team A in FIG. 1 is defined, and the vehicle 320 may be the type of vehicle upon which Team B is defined.

Vehicles 322 and 324 may be of the same type as the vehicle 320, but may differ in that they include appliances and attachments. For example, the vehicle 322 includes a lift appliance for interfacing with particular types of payloads and/or other equipment in the facility such as shelves and racks. The vehicle 324 includes a robotic manipulator arm. According to some embodiments, a vehicle may be included in more than one team, for example, based on a single characteristic or based on more than one characteristic.

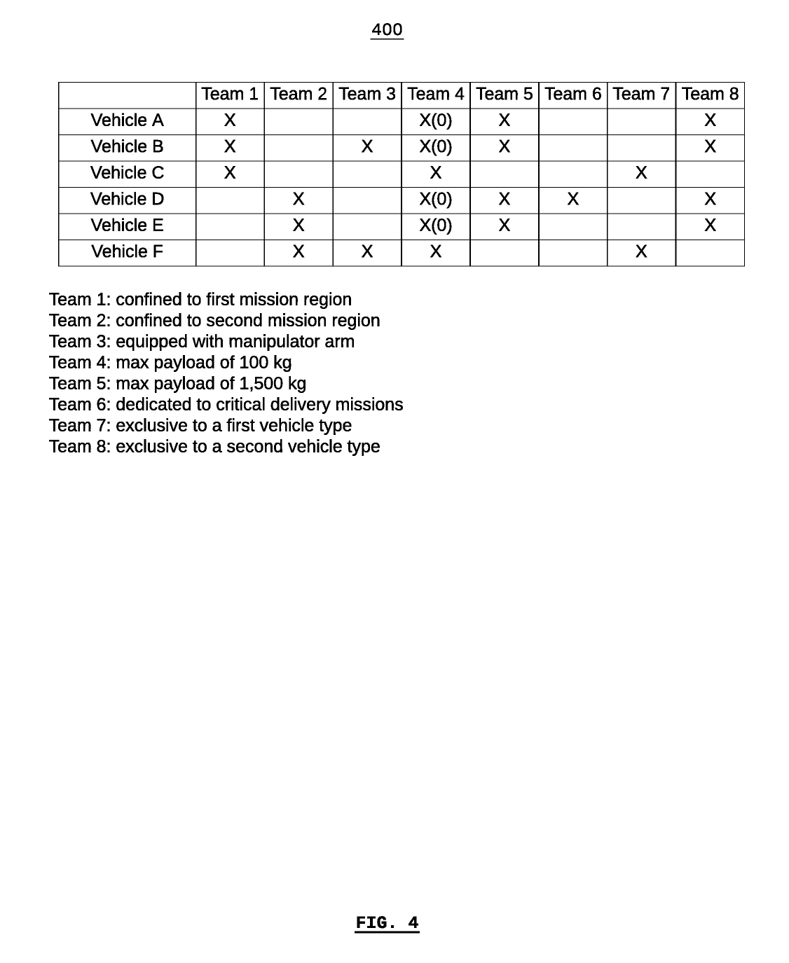

Referring to FIG. 4, there is shown a table 400 describing an example of how vehicle teams may be defined and how vehicles may be included in more than one team. The columns in the table represent unique vehicle teams, and the rows represent unique vehicles. An “X” in a table cell represents that the respective vehicle is a member of the respective team. Generally, the vehicle teams may be defined based on team regions (e.g. corresponding to mission regions), vehicle types and characteristics, and other factors such as requirements for redundancy on a team or the need for mission-critical availability.

In the example, Team 1 is defined based on a first mission region and Team 2 is defined based on a second mission region. The members of Team 1 are Vehicle A, Vehicle B, and Vehicle C. The members of Team 2 are Vehicle D, Vehicle E, and Vehicle F. As such, Team 1 and Team 2 can be considered as complimentary vehicle teams, meaning that none of the vehicles in Team 1 are in Team 2, and all vehicle are on in either Team 1 or Team 2.

Furthermore, Team 7 is defined based on a first vehicle type and Team 8 is defined based on a second vehicle type. The members of Team 7 are Vehicle C and Vehicle F. The members of Team 8 are Vehicle A, Vehicle B, Vehicle D, and Vehicle E. Team 7 and Team 8 can also be considered as complementary vehicle teams. As such, if a mission request pertains to a particular vehicle type, then Team 7 can be managed independently of Team 8. In other words, a vehicle can be selected from one team according to the vehicle type required for the mission without affecting the other team.

Team 4 is defined based a maximum payload of 100 kg, and Team 5 is defined based on a maximum payload of 1,500 kg. According to some embodiments, the definition of Team 4 may be similar to the definition of Team 7, and the definition of Team 5 may be similar to the definition of Team 8. For example, the first vehicle type (Team 7) may have a maximum payload capacity of 100 kg, and the second vehicle type (Team 8) may have a maximum payload capacity of 1,500 kg. In this case, if Team 4 and Team 5 are defined as being complementary vehicle teams, the Team 4 is effectively the same as Team 7, and Team 5 is effectively the same as Team 8.

The symbols “X” and “(0”) are used in the column for Team 4 in order to acknowledge that a vehicle characteristic of “maximum payload” may be defined inclusively or exclusively. In other words, in one interpretation, the set of vehicles that have a maximum payload capacity of 1,500 kg necessarily includes the set of vehicles that have a maximum payload capacity of 100 kg since 100 kg is less than 1,500 kg. In another interpretation, the set of vehicles that have a maximum payload capacity of 100 kg may be deemed to exclude those vehicles that have a maximum payload capacity above 100 kg. Thus, the “X” represents the inclusive set and “0” represents the exclusive set (i.e. complementary vehicle teams).

Team 3 is based on vehicles that are equipped with a manipulator arm. The members of Team 3 vehicle C and Vehicle F. As can be inferred from the table, the members of Team 3 comprise two different types of vehicles; but only those vehicles that include manipulator arms.

Team 6 is based on vehicles that are designated as critical-delivery vehicles, meaning that they are reserved for only those missions that are deemed “critical”. The sole member of Team 6 is vehicle D.

According to some embodiments, if multiple robot teams are defined, and vehicles are members of more than one vehicle team, such as in the example shown in the table 400, then a particular vehicle team may be selected based on the event request. For example, if a mission request requires a vehicle equipped with a manipulator arm, then the mission-scheduling agent may select Team 3, and eventually select Vehicle F. However, if the vehicle state information for Vehicle B indicates triggers a charge event, then the charging agent may select a charging station location based on the fact that Vehicle B is a member of Team 8, since the type of vehicle charging station must correspond to the vehicle type, and may not be dependent on whether or not the vehicle includes a manipulator arm.

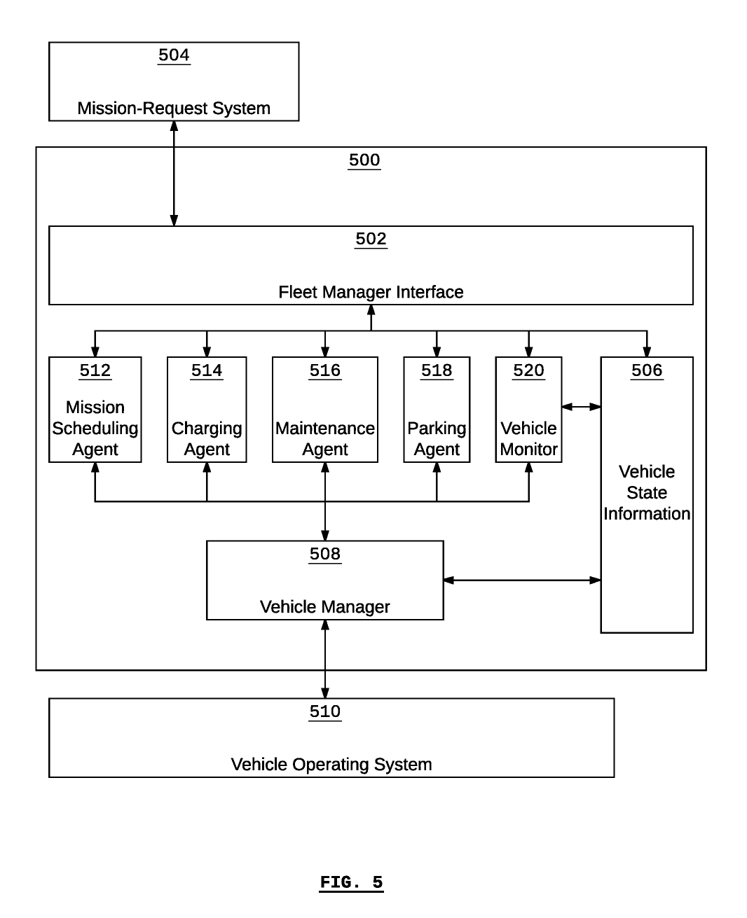

Referring to FIG. 5, there is shown a system diagram for a fleet-management system 500 according to some embodiments. The system may be implemented using non-transitory computer-readable media comprising instructions that, when executed on a computer processor, configure the processor to perform the various algorithms of the fleet-management systems.

Generally, one aspect of the fleet-management system 500 handles event requests, selects a vehicle according to the event request, and then transmits event directions to the selected vehicle based on the event request.

Events may be of several types. Missions are a type of event, and, according to some embodiments, may be the primary type of event, since the primary purpose of a system of materials handling using a fleet of self-driving vehicles may be to perform missions. Other types of events may include vehicle-charging events, maintenance events, and parking events.

According to some embodiments, the fleet-management system 500 may comprise a fleet-manager interface 502 for receiving mission requests from an external system 504. Examples of mission-request systems include enterprise resource planning (“ERP”) systems, manufacturing engineering systems (“MES”), industrial control systems, or other similar systems that handle process control and business logic.

Other types of event requests may be derived based on vehicle state information 506, which may be stored in a database. The vehicle state information database 506 may be in communication with a vehicle manager 508 in order to update the vehicle state information database 506 based on vehicle state data obtained from the vehicle operating systems 510 of individual vehicles.

According to some embodiments, the fleet-management system 500 comprises any one or more of a mission-scheduling agent 512, a charging agent 514, a maintenance agent 516, a parking agent 518, and a vehicle monitor agent 520. Generally, the agents are responsible for handling events, for example, in respect of vehicle teams.

A mission-scheduling agent 512 may be used to schedule a mission based on a request received by the fleet-management interface 502 from an external system 504. A mission may be based on any or all of mission locations (e.g. an original location, one or more task locations, a destination location), a mission payload (e.g. defined in terms of mass, volume, type of payload, etc.), a mission time, tasks required for the mission (e.g. pick up or drop off a payload, manipulate a workpiece with a manipulator arm, etc.), and other physical constrains (e.g. interface requirements for other adjacent equipment, such as conveyors, etc.).

According to some embodiments, the mission-scheduling agent 512 may select a vehicle team from within the fleet of self-driving vehicles in order to execute the mission. For example, and in reference to FIG. 1, if the mission request pertains to a payload that corresponds to or requires the type of vehicle that defines Team B (i.e. the larger type of vehicle, as compared to Team A), then the mission-scheduling agent 512 can select Team B in order to execute the requested mission. Similarly, and in reference to FIG. 2, if the mission request pertains to the mission region 230, then the mission-scheduling agent 512 can select Team C in order to execute the requested mission.

According to some embodiments, it is possible for the mission-scheduling agent 512 to make a series of team selections, as can be seen by combining the examples depicted in FIG. 1 and FIG. 2. For example, if each of Team C and Team D comprise two types of vehicles, as in Team A and Team B, and the mission request pertains to a payload that corresponds to Team B as well as the mission region 230, then the mission-scheduling agent 512 may first select a team based on the mission region 230 and then on the vehicle type (or vis-versa).

Once the mission-scheduling agent 512 has selected a vehicle team, then the mission-scheduling agent 512 may select a vehicle from within the vehicle team. Various criteria and algorithms may be used to select a particular vehicle from within a vehicle team. For example, the mission-scheduling agent 512 may use the vehicle state information 506 to determine which vehicles on the selected team are currently available to execute the mission. Subsequently, the mission-scheduling agent 512 may select an individual vehicle from within the available vehicles on the team in order to optimize the mission for time, distance travelled, vehicle availability for subsequent missions, etc.

Other agents may utilize vehicle states in order to generate event requests. For example, the charging agent 514 may use vehicle state information 506 pertaining to the availability of individual vehicles on a particular vehicle team and the battery-charge levels of the individual vehicles on the team, as well as the availability of charging stations associate with the particular vehicle team in order to generate a charging event for a particular vehicle. For example, the charging agent 514 may operate to optimize the number of vehicles with a minimum charge level within the vehicle team, or optimize the average charge level for all vehicles within the team, and/or optimize the use of available charging stations associated with the team.

The maintenance agent 516 may also utilize vehicle states in order to generate event requests. The maintenance agent 516 may generate a maintenance event request when the vehicle state information 506 is indicative of particular maintenance, malfunction, or error states. For example, the vehicle state information 506 may indicate that no signal or erroneous data is being received from one of the vehicle systems (e.g. a sensor on the vehicle), or that the vehicle is unable to localize itself within the facility, or that the vehicle is unable to move due to the detection of an unsafe condition, or that communications between the vehicle and the fleet-management system 500 have been lost or are erroneous.

According to some embodiments, a maintenance agent 516 may generate event directions based on the maintenance event request. A maintenance event request may comprise any or all of ensuring that the vehicle requiring maintenance (the “disabled vehicle”) ceases any relevant operations, notifying a human operator of the need for maintenance, notifying a human operator of the location of the disabled vehicle, and dispatching a replacement vehicle. According to some embodiments, the replacement vehicle may be selected from the same vehicle team to which the disabled vehicle belongs. According to some embodiments, a vehicle team may be defined such that all of the vehicles in the team are deemed to be replacement vehicles that are available to be included in another vehicle team when a vehicle in the vehicle team becomes a disabled vehicle. According to some embodiments, the maintenance agent 516 may generate a mission request that can be handled by the mission-scheduling agent 512 such that the mission-scheduling agent 512 can select a replacement vehicle (e.g. from the same vehicle team to which a disabled vehicle belongs, or from a team of replacement vehicles), and generate mission directions for the replacement vehicle that are based on the mission directions being executed by the disabled vehicle.

The parking agent 518 may also utilize vehicle states in order to generate event requests. The parking agent 518 may generate a parking event request when the vehicle state information 506 is indicative of in activity of one or more vehicles. For example, if a vehicle is not executing a mission, scheduled to execute a mission, charging, or disabled (requiring maintenance), then it may be eligible for a parking event.

According to some embodiments, the parking agent 518 may generate event directions based on the parking event request. The parking event request may comprise one or more parking locations. According to some embodiments, the parking location may be selected based on the team to which the subject vehicle belongs. In other words, particular parking locations may be designated for use by one or more particular vehicle teams.

For example, and in reference to FIG. 1, one or more parking locations may be designated for use by the vehicles in Team A, while one or more other parking locations may be designated for by use the vehicles in Team B. Since Team A and Team B may be defined based on vehicle type, which may be associated with vehicle size, the vehicles from Team B may not fit in the space available for the parking locations associated with Team A. According to some embodiments, Team A and Team B may be defined based on vehicle type, and the parking locations may be designated to the particular teams based on location, for example, if one type of vehicle is expected to generally operate in one area of the facility and another type of vehicle is expected to generally operate in another area of the facility, despite the fact that the vehicle teams may not be explicitly defined in terms of team regions associated with mission regions.

Similarly, and in reference to FIG. 2, parking locations located designated for use by Team C may be defined in association with the mission region 230, while parking locations designated for use by Team D may be defined in association with the mission region 240.

According to some embodiments, the vehicle monitor 520 may operate to update the vehicle state information 506 on a continuous, periodic, scheduled, or arbitrary time base via the vehicle manager 508, and/or to coordinate the retrieval of vehicle state information for other agents.

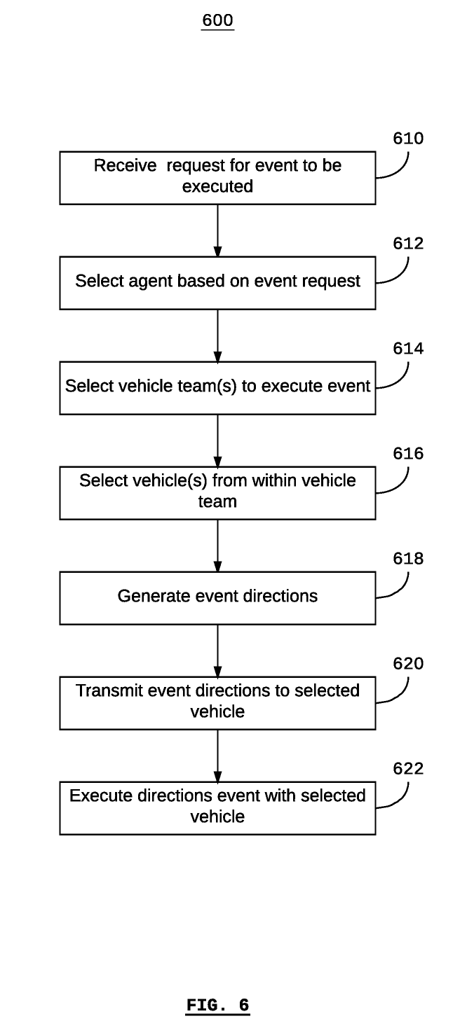

Referring to FIG. 6, there is shown a flow diagram depicting a method 600 of assigning an event to a fleet of self-driving vehicles. The method 600 may be implemented using one or more computer processors, such as those included in any or all of a fleet-management system and self-driving material-transport vehicle a fleet-management system (e.g. on a computer terminal or server). Non-transitory computer-readable media associated with one or more processors may store computer-readable instructions for configuring the one or more processors to execute the steps of the method 600.

The method 600 begins at step 610 when an event request is received. According to some embodiments, an event request may be a mission request, or other event request such as a battery-charge event request, a maintenance event request, or a parking request. A mission request may be received from a mission-request system such as an ERP, MES, industrial control systems, or other similar systems that handle process control and business logic. Event requests may be generated based on vehicle state information.

At step 612, an agent may be selected based on the event request, according to some embodiments. For example, if the event request is a mission request, then a mission-scheduling agent may be selected. If the event is a battery-charge event, then a charging agent may be selected. According to some embodiments, an agent may be “selected” in the sense that it self-selects; that is, the agent may contribute to the generation of the event request, in which case the agent may implicitly be selected.

At step 614, one or more vehicle teams is selected. According to some embodiments, a vehicle team may be selected based on the type of event request, the information pertaining to the event request, or the vehicle to which the event request pertains. For example, a fleet may comprise four vehicle teams, including two complementary vehicles teams based on two mission regions, and two complementary teams based on the type of charging station compatible with the vehicles. If the event request is a mission request, and the mission request pertains to a mission region, then the mission-scheduling agent may select one of the teams based on the mission region. However, if the event request is a battery-charge event request, then the charging agent may select a vehicle team (i.e. a charging-station type) based on the type of vehicle associated with the vehicle that needs to be charged.

At step 616, a particular vehicle is selected from within the selected vehicle team. For example, if the event request is a mission request, then the vehicle selection may be based on any or all of an optimization of the time required to execute the mission, distance travelled, vehicle availability for subsequent missions, etc. If the event request is a maintenance event request, then the vehicle selection may simply be a matter of identifying the vehicle for which the maintenance event request was generate, in other words, based on the vehicle state information.

At step 618, event directions are generated based on the event request. For example, if the event request is a mission request, then the event directions may pertain to the locations and tasks required to fulfill the mission request. If the event request is a battery-charge request, then the event directions may pertain to a charging station location.

At step 620, the event directions are transmitted to the selected vehicle. For example, the fleet-management system may transmit the event directions to the vehicle using a wireless communications network. At step 622, the selected vehicle executes the event directions.

The present invention has been described here by way of example only. Various modification and variations may be made to these exemplary embodiments without departing from the spirit and scope of the invention, which is limited only by the appended claims.

We claim:

1. A method for assigning an event to a fleet of self-driving vehicles, comprising:
receiving, with a fleet-management computer system, a request for the event to be executed;
selecting a vehicle team from within the fleet based on the request;
selecting a vehicle from within the vehicle team;
transmitting event directions to the selected vehicle based on the request for the event; and
executing the event directions with the selected vehicle.

2. Non-transitory computer-readable media comprising one or more instructions for assigning an event to a fleet of self-driving vehicles that, when executed on a processor, configure the processor to:
receiving a request for the event to be executed;
select a vehicle team from within the fleet based on the request;
select a vehicle from within the vehicle team; and
transmit event directions to the selected vehicle based on the request for the event.

3. The media of claim 2, wherein the instructions, when executed on the processor configure the processor to:
prior to selecting the vehicle team from within the fleet, selecting an agent from among a plurality of agents based on the request;
wherein selecting the vehicle from within the fleet based on the request is based on the selected agent.

4. The media of claim 3, wherein the event is a self-driving vehicle mission and the agent is a mission-scheduling agent.

5. The media of claim 4, wherein:
the mission pertains to a mission region;
the fleet comprises two or more vehicle teams defined based on respective team regions; and
the vehicle team is selected based on the mission region and the two or more team regions.

6. The media of claim 3, wherein the request is a battery-charge request based on vehicle-state information of a low-charge vehicle, and the agent is a charging agent.

7. The media of claim 6, wherein:
the fleet comprises two or more vehicle teams defined based on respective team regions; and
the event directions comprise a charging-station location selected based on the respective team region associated with the vehicle team comprising the low-charge vehicle.

8. The media of claim 6, wherein:
the fleet comprises two or more vehicle teams defined based on respective charging station types; and
the event directions comprise a charging-station location selected based on the respective charging station type associated with the vehicle team comprising the low-charge vehicle.

9. The media of claim 3, wherein the event is a maintenance event based on vehicle-state information from a disabled vehicle, the agent is a maintenance agent, and the maintenance agent adds a replacement vehicle to the vehicle team associated with the disabled vehicle.

10. A system for materials handling using a fleet of self-driving vehicles, comprising:
two or more vehicle teams that comprise the fleet of self-driving vehicles; and
a fleet-management system having a processor and non-transitory computer-readable media comprising one or more instructions that, when executed on the processor configure the processor to:
provide a fleet-manager interface for receiving a mission request;
provide at least one agent for selecting a vehicle team from within the fleet based on the mission request;
provide a vehicle broker for selecting a vehicle from within the selected vehicle team based on the mission request; and
transmit mission directions to the selected vehicle based on the mission request;
wherein the fleet-manager interface is a single fleet-manager interface configured to receive mission requests pertaining to any of the vehicle teams.

11. The system of claim 10, wherein the two or more vehicle teams are defined based on vehicle payload capacity such that all vehicles in each team have the same payload capacity as each other, and all vehicles in each team have a different payload capacity as vehicles in other vehicle teams.

12. The system of claim 10, wherein the two or more vehicle teams are defined based on team regions such that all vehicles in each team have the same team region as each other, and all vehicles in each team have a different team region as vehicles in other vehicle teams.
